(19) United States
(12) Patent Application Publication
(10) Pub. No.: US 2025/0372604 A1
(43) Pub. Date: Dec. 4, 2025

(54) ELECTRODE SHEET MANUFACTURING APPARATUS

(71) Applicant: Prime Planet Energy & Solutions, Inc., Tokyo (JP)

(72) Inventor: Yoshihiko SASAKI, Himeji-shi (JP)

(21) Appl. No.: 19/215,334

(22) Filed: May 22, 2025

(30) Foreign Application Priority Data
May 28, 2024 (JP) 2024-086691

(51) Int. Cl. H01M 4/04; H01M 4/66; H01M 4/75

(52) U.S. Cl. CPC H01M 4/0435; H01M 4/0404; H01M 4/661; H01M 4/75

(57) ABSTRACT

For an electrode sheet manufacturing apparatus, a pressure roll is disposed so as to hold an unformed portion of the electrode sheet between the pressure roll and a support roll, except for a portion of the electrode sheet on which an active material layer is formed. The pressure roll is a rubber roll at least an outer circumferential surface of which is made of a rubber. The rubber satisfies the following expression: y1≥y2>0.8×y1, where y1 is the modulus of longitudinal elasticity of the rubber at 25° C. and y2 is the modulus of longitudinal elasticity of the rubber at 60° C.

### CROSS REFERENCE TO RELATED APPLICATIONS

The present application claims priority from Japanese Patent Application No. 2024-086691 filed on May 28, 2024, which is incorporated by reference herein in its entirety.

### BACKGROUND

The present invention relates to an electrode sheet manufacturing apparatus.

JP 2023-036089 A discloses a method of manufacturing an electrode sheet including a coated portion, in which an active material layer containing an electrode material is coated on a metal foil, and an uncoated portion defined at an end portion of the coated portion. The manufacturing method disclosed in the publication discloses that the uncoated portion is pressed by a pair of elastic rolls when roll-pressing the electrode sheet. By pressing the uncoated portion using the pair of elastic rolls, compressive force and deformation force can be applied to the same location in the uncoated portion. It is stated that this allows the uncoated portion to be stretched while preventing breakage of the uncoated portion.

### SUMMARY

The present inventor has found that, when roll-pressing the uncoated portion (unformed portion) of the electrode sheet by the process as described above, variations occur in the amount of elongation of the uncoated portion. The present inventor intends to stabilize the amount of elongation of the uncoated portion.

According to the present disclosure, an electrode sheet manufacturing apparatus is provided that manufactures an electrode sheet, which includes a current collector made of an oblong metal foil, an unformed portion defined along a longitudinal axis of the current collector at a predetermined widthwise position in the current collector, and an active material layer formed on a portion of the current collector other than the unformed portion.

The electrode sheet manufacturing apparatus includes:
a conveyor device conveying the electrode sheet along a predetermined conveyance passage;
a support roll disposed in the conveyance passage and supporting a first surface of the electrode sheet along a width axis;
a pressure roll disposed opposite the support roll and pressing a second surface of the electrode sheet;
a pressing mechanism holding the electrode sheet and pressing the pressure roll toward the support roll; and
a drive device rotatively driving the support roll.

The pressure roll is disposed so as to hold the unformed portion of the electrode sheet between the pressure roll and the support roll, except for a portion of the electrode sheet on which the active material layer is formed. The pressure roll is a rubber roll at least an outer circumferential surface of which is made of rubber. The rubber satisfies the following expression: y1≥y2≥0.8×y1, where y1 is the modulus of longitudinal elasticity of the rubber at 25° C. and y2 is the modulus of longitudinal elasticity of the rubber at 60° C.

The electrode sheet manufacturing apparatus as described above is able to control the deformation of the pressure roll to a certain level, to reduce heat generation. As a result, it is possible to stabilize the amount of elongation of the uncoated portion of the electrode sheet stretched by an EPS device.

### BRIEF DESCRIPTION OF THE DRAWINGS

FIG. 1 is a manufacturing flowchart illustrating an electrode sheet manufacturing method.

FIG. 2 is a schematic view of an electrode sheet 10.

FIG. 3 is a schematic view illustrating another embodiment the electrode sheet 10.

FIG. 4 is a schematic view illustrating an electrode sheet manufacturing apparatus 100.

FIG. 5 is a front view illustrating an EPS device 110 shown in FIG. 4, viewed from a conveying direction of the electrode sheet 10.

FIG. 6 is a schematic side view illustrating the behavior of a pressure roll 112 when rolling an uncoated portions 12a by EPS.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are depicted schematically and do not necessarily accurately depict actual objects. The features and components that exhibit the same effects are designated by the same reference symbols as appropriate, and the description thereof will not be repeated as appropriate. Unless specifically stated otherwise, the recitation of numerical ranges in the present description, such as “X to Y”, is meant to include any values between the upper limits and the lower limits, inclusive, that is, “greater than or equal to X to less than or equal to Y”.

FIG. 1 is a manufacturing flowchart illustrating an electrode sheet manufacturing method. As illustrated in FIG. 1, the electrode sheet manufacturing method includes a conveying step S1, a measuring step S2, a kneading step S3, a coating step S4, a drying step S5, and a roll-pressing step S6. However, the electrode sheet manufacturing method may include other steps.

### Electrode Sheet 10

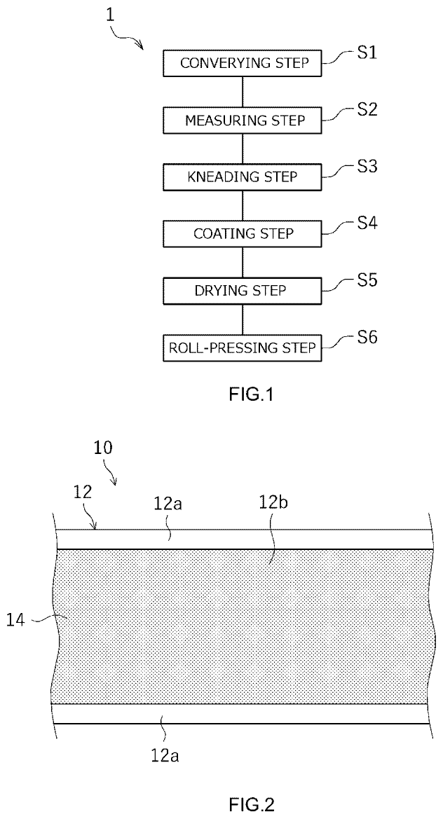

FIG. 2 is a schematic view of an electrode sheet 10. The electrode sheet 10 constitutes a positive electrode sheet or a negative electrode sheet of an electrode assembly that is to be accommodated in the inside of the electricity storage device. The term “electricity storage device” refers to a repeatedly chargeable device, and it is intended to encompass what is called storage batteries (chemical cells), such as lithium-ion secondary batteries, nickel-metal hydride batteries, and nickel-cadmium batteries, as well as capacitors (i.e., physical cells) such as electric double-layer capacitors.

As illustrated in FIG. 2, the electrode sheet 10 includes a current collector 12 and an active material layer 14. The current collector 12 is a member that is made of a metal foil. The current collector 12 is an oblong strip-shaped metal member. For the current collector 12, it is possible to use a metal material that has required electrical conductivity. For positive electrode current collector foil, it is possible to use, for example, aluminum, aluminum alloys, or the like. For negative electrode current collector foil, it is possible to use, for example, copper, copper alloys, or the like. The active material layer 14 is coated on a predetermined position within the current collector 12. The active material layer 14 is formed on at least one surface of the strip-shaped current collector 12. In this embodiment, the active material layer 14 is formed on both surfaces of the current collector 12. The active material layer 14 is a layer containing an electrode active material. For positive electrode active material, it is possible to use, for example, lithium-transition metal composite oxides. For negative electrode active material, it is possible to use, for example, carbon materials, silicon based materials, and composite oxides thereof. The active material layer may also contain additive agents other than the electrode active material, such as binders and conductive agents.

The electrode sheet 10 is formed by coating an electrode mixture slurry, which forms the active material layer 14, onto the current collector 12, and drying. The current collector 12 is provided with uncoated portions 12a (i.e., unformed portions) and a coated portion 12b. The uncoated portions 12a are portions of the current collector 12 on which the active material layer 14 is not coated. The uncoated portions 12a are defined along a longitudinal axis of the electrode sheet 10 in widthwise end portions of the electrode sheet 10. In this embodiment, the uncoated portions 12a are defined at both widthwise ends of the electrode sheet 10. The coated portion 12b is disposed between the uncoated portions 12a at both ends of the electrode sheet 10. The electrode mixture slurry is coated onto the coated portion 12b. As a result, the active material layer 14 is formed on the coated portion 12b of the current collector 12. That is, the active material layer 14 is disposed between the uncoated portions 12a at both widthwise ends of the electrode sheet 10. Thus, the electrode sheet may include the current collector 12 made of an oblong metal foil, unformed portions (uncoated portions 12a herein) defined along the longitudinal axis of the current collector 12 at predetermined widthwise positions in the current collector 12, and the active material layer 14 formed on a portion of the current collector 12 other than the unformed portions.

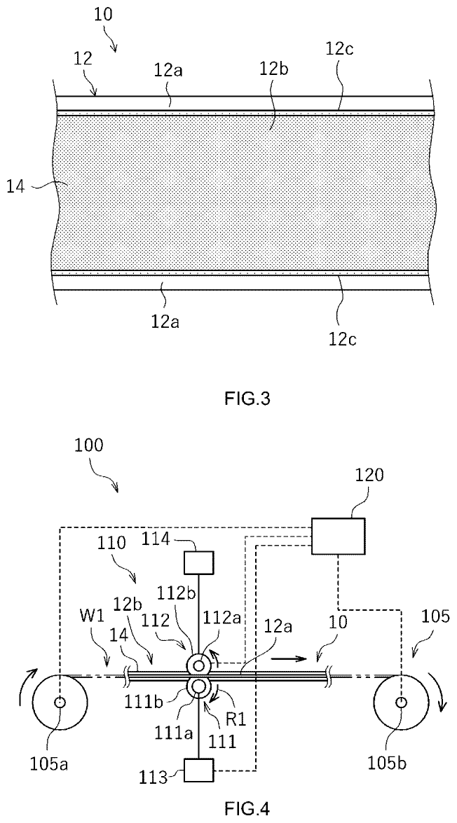

FIG. 3 is a schematic view illustrating another embodiment the electrode sheet 10.

As illustrated in FIG. 3, the electrode sheet 10 may be provided with an insulative protective layer 12c at a position in each uncoated portion 12a that is adjacent to the coated portion 12b. Such a structure may be employed in, for example, an electrode sheet 10 used for positive electrode. Providing the protective layer 12c on the electrode sheet 10 used for positive electrode can prevent short circuits between the positive electrode current collector foil and the negative electrode active material layer. Such a protective layer 12c contains an insulative inorganic filler. Examples of the inorganic filler include insulating particles, for example, ceramic particles, such as alumina. The protective layer 12c may contain a binder, for example. The binder may be the same as those illustrated as can be contained in the positive electrode active material layer. In the following, FIGS. 2 and 3 are referred to as appropriate for the constituent components of the electrode sheet 10, even when not specifically stated so.

### Conveying Step S1, Measuring Step S2, Kneading Step S3, Coating Step S4, Drying Step S5

In the conveying step S1 shown in FIG. 1, the electrode sheet 10 is conveyed. The conveying step S1 involves conveying the electrode sheet 10 along a predetermined conveyance passage W1. The measuring step S2 involves weighing source materials for the active material layer 14 (see FIG. 2). The weighing may be implemented with a weighing device (not shown) that includes, for example, a balance scale, a load cell, or the like. The weighed source materials for the active material layer 14 are mixed in the kneading step S3. The kneading step S3 may be implemented by a kneading device (not shown). The source materials for the active material layer 14 that have been made into a slurry state by the kneading device are coated onto the current collector 12 (see FIG. 2) in the coating step S4. The coating step S4 may be implemented by, for example, a coating device (not shown), such as a slit coater, a gravure coater, a die-coater, or a comma coater. The drying step S5 involves drying the slurry-state source materials for the active material layer 14 that have been coated. The drying step S5 may be implemented by, for example, a dryer device (not shown) that generates hot air or emits infrared rays.

### Roll-Pressing Step S6

The roll-pressing step S6 is a step of roll-pressing the electrode sheet 10. Herein, the substrate material for the electrode sheet 10 is a metal foil. The electrode sheet 10 includes a portion on which the active material layer 14 is formed (i.e., coated portion 12b) and a portion on which the active material layer 14 is not formed (i.e., uncoated portion 12a). The roll-pressing step S6 is mainly intended to adjust the active material layer 14 formed by coating to have an appropriate density.

In the roll-pressing step S6, the coated portion 12b is roll-pressed in order to allow the active material layer 14 to have an appropriate density. When the coated portion 12b is roll-pressed, the substrate material, the current collector 12 is stretched in the coated portion 12b. However, in the uncoated portions 12a, the pressing pressure is not directly transmitted to the current collector 12, so the current collector 12 is not easily stretched in the uncoated portions 12a. Accordingly, in the state in which the coated portion 12b alone is pressed, variations in elongation may occur between the coated portion 12b and the uncoated portions 12a. When variations in elongation are large between the coated portion 12b and the uncoated portions 12a, it may be a cause of wrinkles that form in the electrode sheet 10. The uncoated portions 12a are cut into predetermined shapes in a later processing step to form tabs. In this case, if wrinkles occur in the uncoated portions 12a, the tabs may not be formed into an appropriate shape.

In order to prevent the wrinkles from forming in the electrode sheet 10, the current collector 12 may be stretched in the uncoated portions 12a before or after roll-pressing the coated portion 12b. One technique of stretching the current collector 12 in the uncoated portions 12a is a technique of pressing the uncoated portions 12a by means of a rubber roll. The technique of pressing the uncoated portions 12a by means of a rubber roll may be referred to as EPS (Elasticity Powered Stretching) as appropriate. The device that presses the uncoated portions 12a by a rubber roll may be referred to as an EPS device as appropriate.

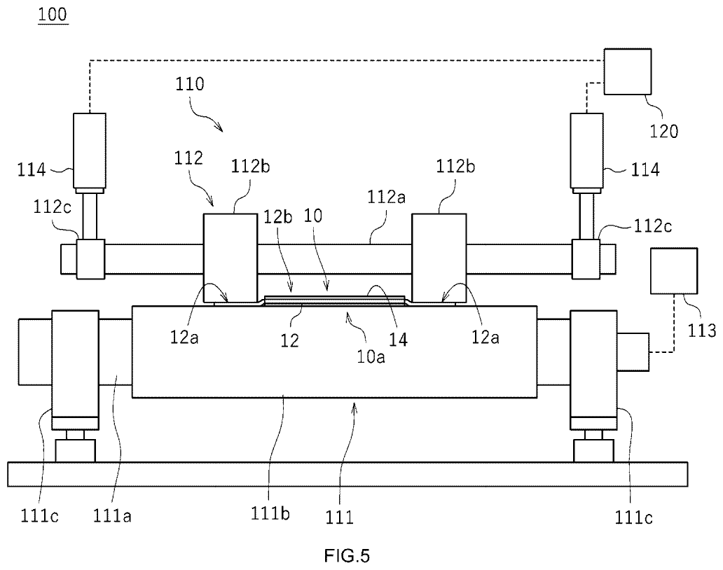

FIG. 4 is a schematic view illustrating an electrode sheet manufacturing apparatus 100. The electrode manufacturing apparatus 100 includes a conveyor device 105 that conveys an electrode sheet 10 and what is called an EPS device 110. FIG. 4 shows a side view of such an EPS device 110. FIG. 5 is a front view illustrating the EPS device 110 shown in FIG. 4, viewed from a conveying direction of the electrode sheet 10.

The conveyor device 105 is, as illustrated in FIG. 4, a device that conveys a strip-shaped electrode sheet 10 along a predetermined conveyance passage W1. In the embodiment shown in FIG. 4, the electrode sheet 10 is fed by a feed roll 105a, conveyed along a predetermined conveyance passage W1, and taken up on the winding roll 105b. As illustrated in FIG. 4, the EPS device 110 is disposed in the middle of the conveyance passage W1 of the electrode sheet 10.

### EPS Device 110

As illustrated in FIG. 4, the EPS device 110 is composed of a roll press machine including a support roll 111 and a pressure roll 112.

### Support Roll 111

As illustrated in FIG. 5, the support roll 111 is a roll that is disposed in the conveyance passage W1 and supports, along a width axis, a first surface 10a (lower surface in this embodiment) of the electrode sheet 10 conveyed along the conveyance passage W1. In this embodiment, the support roll 111 is composed of a shaft 111a and a rubber 111b covering the outer circumferential surface of the shaft 111a. The shaft 111a may be made of a metal, such as stainless steel. The rubber 111b may be a rubber material, such as nitrile rubber (NBR), for example. The rotating shaft 111a of the support roll 111 is attached to a drive device 113. The shaft 111a of the support roll 111 is rotatably supported by a pair of support parts 111c. Although not shown in the drawings, the pair of support parts 111c may include bearings that support the shaft 111a of the support roll 111. The drive device 113 is a device that rotatively drives the support roll 111. The drive device 113 may be a device that causes the support roll 111 to rotate at a predetermined rate along the conveying direction of the conveyance passage W1. The drive device 113 is connected to a controller 120 and is configured to be able to change the rotational speed of the support roll 111 appropriately. In the embodiment shown in FIG. 4, the support roll 111 is illustrated to be a roll member composed of the shaft 111a and the rubber 111b covering the outer circumferential surface of the shaft 111a, but this is merely illustrative. The support roll 111 may be a rubber roll at least the outer circumferential surface of which is made of rubber. In the embodiment shown in FIG. 4, the support roll 111 is a rubber roll the surface of which is rubber, but the support roll 111 may be a metal roll the surface of which is metal.

### Pressure Roll 112

The pressure roll 112 is a roll that is disposed opposite the support roll 111 and presses a second surface 10b (upper surface in this embodiment) of the electrode sheet 10. The pressure roll 112 is disposed so as to hold the uncoated portions 12a of the electrode sheet between the pressure roll 112 and the support roll 111, except for the uncoated portions 12a of the electrode sheet 10. The pressure roll 112 is a rubber roll at least an outer circumferential surface of which is made of rubber 112b.

In this embodiment, the pressure roll 112 is a roll in which rubber 112b is formed on the outer circumference of a shaft 112a made of a metal such as stainless steel. As illustrated in FIGS. 4 and 5, rings of the rubber 112b are disposed on the shaft 112a, spaced along the axial direction at a predetermined gap, so as to hold the uncoated portions 12a of the electrode sheet 10. The shaft 112a of the pressure roll 112 is supported by roll chocks 112c including bearings so that the pressure roll 112 is driven-rotated. The rotating shaft 112a of the pressure roll 112 is mounted via roll chocks 112c to a pressing mechanism 114 that presses the pressure roll 112 toward the support roll 111. For the pressing mechanism 114, it is possible to employ, for example, a cylinder mechanism used in press machines or the like. The pressing mechanism 114 is connected to the controller 120.

As illustrated in FIGS. 4 and 5, the uncoated portions 12a of the electrode sheet 10 are conveyed between the support roll 111 and the pressure roll 112. The support roll 111 rotates in the direction indicated by arrow R1 shown in FIG. 4. The pressure roll 112 is pressed against the support roll 111 with the uncoated portions 12a of the electrode sheet 10 being held therebetween. The pressure roll 112 is driven-rotated in the direction indicated by arrow R2 according to the rotation of the support roll 111 and the travel of the electrode sheet 10. The uncoated portions 12a of the electrode sheet 10 are conveyed while being held between the support roll 111 and the pressure roll 112. In such an EPS device, the surface of the pressure roll 112 is rubber. The pressure roll 112 is pressed against the support roll 111 while holding the electrode sheet 10 therebetween, and it rotates while it partially undergoes deformation. The uncoated portions 12a of the electrode sheet 10 are conveyed while being held between the support roll 111 and the pressure roll 112, and are stretched in the conveying direction at that time. Thus, the EPS device 110 is able to allow a stretching force to act on the uncoated portions 12a of the electrode sheet 10 by the compressive force and elastic deformation of the rubber 112b of the pressure roll 112, without applying high tension to the electrode sheet 10, to stretch the uncoated portions 12a of the electrode sheet 10.

Herein, the thickness (height in a radial direction) of the rubber 112b of the pressure roll 112 may be, for example, from 1 mm to 30 mm, preferably from 5 mm to 20 mm. In this embodiment, the thickness (height in a radial direction) of the rubber 112b used for the pressure roll 112 is set to 10 mm. Note that the thickness (height in a radial direction) of the rubber 112b of the pressure roll 112 is not limited to a particular thickness, unless specifically stated otherwise.

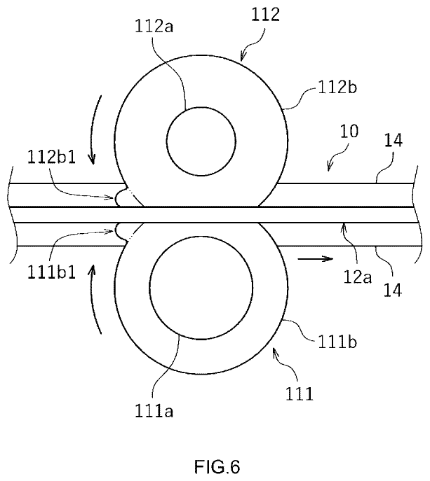

The present inventor has found an event in which variations in elongation rate occur when stretching the uncoated portions 12a by EPS. The present inventor investigated the cause of such an event and found the following. During the processing by EPS, the rubber 112b of the pressure roll 112 generates heat. FIG. 6 is a schematic side view illustrating the behavior of the pressure roll 112 when rolling an uncoated portions 12a by EPS. When the rubber 112b generates heat, the elastic modulus of the rubber 112b of the pressure roll 112 decreases, and accordingly deformation becomes large. When the elastic modulus of the rubber 112b decreases and deformation becomes large, a bulge 112b1 (outer surface rising) or the like may occur on the surface of the rubber 112b, as illustrated in FIG. 6. In the embodiment shown in FIG. 6, the outer surface of the support roll 111 is the rubber 111b. When the outer surface of the support roll 111 is the rubber 111b, a bulge 111b1 (outer surface rising) may occur also on the rubber 111b on the outer surface of the support roll 111, as illustrated in FIG. 6.

The bulges 111b1 and 112b1 tend to form at the end on the respective outer circumferential surfaces of the pressure roll 112 and the support roll 111 that hold the uncoated portions 12a of the electrode sheet 10 therebetween. (i.e., upstream end of the pressure roll 112). As for the event in which the bulges 111b1 and 112b1 form, the present inventor considers as follows. The rubbers 111b and 112b are viscoelastic bodies, so they tend to return to their original shape when a certain level of strain is applied thereto. Herein, in the Maxwell model of viscoelasticity, the spring corresponds to an elastic component and the dashpot corresponds to a viscous component. Although the elastic component returns quickly, the viscous component takes time to return. As a consequence, raised portions (bulges 111b1 and 112b1) form at the end where the uncoated portions 12a of the electrode sheet 10 are sandwiched. This ratio of elasticity and viscosity can be changed by varying the composition of the rubber.

In EPS, while the support roll 111 and the pressure roll 112 are rotating, they continuously press the uncoated portions 12a of the electrode sheet 10. In this case, elasticity and viscosity are represented by storage tensile modulus (E1) and loss tensile modulus (E2), for dynamic viscoelasticity (when strain is applied continuously). This ratio E2/E1 is called loss tangent (loss factor), which is represented by tan δ. Loss tangent (tan δ) indicates how much energy a material absorbs (how much heat the material dissipates) when the material undergoes deformation. Also, its complex modulus E* can be expressed as E1+iE2. Herein, it is preferable that the loss tangent (tan δ) of the support roll 111 and the pressure roll 112 be 0.03 to 0.20 at 30° C. (i.e., tan δ (@30° C.)), more preferably 0.03 to 0.10.

According to the study by the present inventor, when the viscosity is high, generated heat is high. In addition, when the viscosity is high, the amount of strain is large. When a rubber with a low viscosity is produced, the amount of heat generation is kept low. Heat generation reduces an increase in viscous component. From such a viewpoint, the present inventor has conceived that the EPS device allows the viscosity of the rubber 112b of the pressure roll 112 to be appropriate in the use temperature range in the EPS device, to reduce the temperature dependency of the modulus of longitudinal elasticity. Reducing the temperature dependency of the modulus of longitudinal elasticity of the rubber 112b of the pressure roll 112 in the use temperature range in the EPS device reduces the temperature increase in the EPS device and the viscosity increase, making it possible to stabilize the elongation rate of aluminum foil. Herein, although the description has explained concerning the pressure roll 112, the same applies to the support roll 111 when the outer surface of the support roll 111 is rubber.

Herein, the electrode sheet 10 to be subjected is not limited to any particular one. For example, an aluminum foil with a thickness of about 10 μm to about 15 μm is used for the uncoated portions 12a of the electrode sheet 10 used for positive electrode. On the other hand, a copper foil is used for negative electrode. Because of such a difference in current collector foil, the electrode sheet 10 used for positive electrode is easier to break than the electrode sheet for negative electrode. Herein, the process of stretching the uncoated portions 12a of the electrode sheet 10 used for positive electrode by EPS is the main subject of evaluation. However, the material for the rubber used for the pressure roll 112 of the EPS device and the material for the current collector foil (uncoated portion 12a) of the electrode sheet 10 to be subjected are not limited to any particular ones unless specifically stated otherwise.

According to the discovery by the present inventor, the bulge 112b1 that forms on the surface of the rubber 112b changes in size due to the heat generation of the rubber 112b during the processing by EPS. The greater the size of the bulge 112b1, the greater the elongation of the uncoated portions 12a of the electrode sheet 10 tends to be.

The electrode sheet manufacturing apparatus 100 proposed herein is configured so that the rubber 112 of the outer surface of the pressure roll 112 satisfies the following expression y1≥y2≥0.8×y1, where y1 is the modulus of longitudinal elasticity of the rubber 112 at 25° C. and y2 is the modulus of longitudinal elasticity of the rubber 112 at 60° C. That is, because the rubber 112b of the outer surface of the pressure roll 112 is configured to satisfy the expression y1≥y2≥0.8×y1, it is expected that the modulus of longitudinal elasticity of the pressure roll 112 is stabilized in the use temperature range (25° C. to 60° C.) in the EPS device, and the amount of elongation of the uncoated portions 12a of the electrode sheet 10 that is stretched by the EPS device is stabilized.

Here, the electrode sheet manufacturing apparatus 100 generates heat in use, and the range of heat generation is approximately from room temperature to 60° C. In the electrode sheet manufacturing apparatus 100 proposed herein, the rubber 112 of the outer surface of the pressure roll 112 has a modulus of longitudinal elasticity y2 at 60° C. that is less than or equal to the modulus of longitudinal elasticity y1 at 25° C. and is greater than 0.8×y1. That is, the modulus of longitudinal elasticity of the rubber 112b of the outer surface of the pressure roll 112 may have low dependency on temperature in the range of 25° C. to 60° C. This serves to stabilize the size of the bulge in the use temperature range in EPS. As a result, the elongation rate of the uncoated portions 12a of the electrode sheet 10 can be stabilized. From such a viewpoint, it is preferable that the rubber 112b of the outer surface of the pressure roll 112 have a modulus of longitudinal elasticity that shows low dependency on temperature in the range of from 25° C. to 60° C., more preferably y2≥0.85×y1, and still more preferably y2≥0.90×y1.

In addition, the rubber 112b may have a modulus of longitudinal elasticity at 25° C., y1, in the range 20 MPa≤y1≤26 MPa. This allows the rubber 112b to provide a required elastic force in the processing by EPS, to appropriately stretch the uncoated portions 12a of the electrode sheet 10.

Also, the rubber 112b may have a hardness at 25° C. of 92±3. This allows the rubber 112b in the processing by EPS to reduce the deformation of the rubber 112b, to reduce the heat generation of the rubber 112b, and thus control the size of the bulge 112b1 to be smaller.

It should be noted that the physical properties of the rubber 112b of the pressure roll 112 that are shown as preferable examples herein are those used when processing the uncoated portions of the positive electrode. It is also possible to use a pressure roll provided with a rubber that has the same or similar physical properties when processing the uncoated portions (unformed portions) of the negative electrode. According to the discovery by the present inventor, it is desirable to employ a rubber that is hard and less likely to be affected by the viscosity component for the pressure roll. The present inventor believes that, when the uncoated portion is a copper foil, it is desirable to use a rubber that is similarly or less likely to be affected by the viscous component (in other words, less likely to cause a bulge) than that used for processing aluminum, because copper is more easily stretched than aluminum.

The EPS device 110 may be configured to control the temperature of the rubber 112b to be lower than or equal to a predetermined temperature that is lower than or equal to 60° C. when stretching the uncoated portions 12a by holding the electrode sheet 10 between the pressure roll 112 and the support roll 111. From such a viewpoint, the EPS device 110 may employ a cooling mechanism, such as blowing cold air onto the pressure roll 112. The present inventor constructed an EPS device 110 on a trial basis to conduct verification. Herein, a rolling process for uncoated portions 12a of an 12000 m-long electrode sheet 10 was carried out while conveying the electrode sheet 10 at 100 m/min. In the rolling process for the uncoated portions 12a of the electrode sheet 10, the pressing force of the pressure roll 112 was adjusted appropriately.

Herein, the uncoated portions 12a of the electrode sheet 10 are made of a 12 μm-thick aluminum foil. For the pressing force of the pressure roll 112, the output power of the cylinder mechanism as the pressing mechanism 114 was set to 2900 N to 2600 N. The output power of the cylinder mechanism as the pressing mechanism 112 was adjusted to about 0.14 MPa to about 0.12 MPa in terms of the surface pressure of the pressure roll 112. Specifically, the pressing force of the pressure roll 112 was set so that the output power of the cylinder mechanism was 2900 N and about 0.14 MPa in terms of the surface pressure of the pressure roll 112 at the initial stage of processing. Over the time of processing by EPS, the pressure roll 112 generates heat. The output power of the cylinder mechanism was reduced according to the heat generated by the pressure roll 112 so that the output power of the cylinder mechanism was set to 2600 N and about 0.12 MPa in terms of the surface pressure of the pressure roll 112. In the verification, when the electrode sheet 10 was conveyed 6000 m at 100 m/min, the temperature of the pressure roll 112 increased from 25° C. to about 40° C., then followed by a gradual temperature increase, and increased to about 41° C. Thereafter, conveying of the electrode sheet 10 was temporarily stopped to lower the temperature of the pressure roll 112 to about 34° C., and thereafter, the remaining 6000 m-long electrode sheet 10 was conveyed at 100 m/min, to carry out the processing by EPS. In this case as well, the temperature of the pressure roll 112 increased to about 40° C., then followed by a gradual temperature increase, and finally increased to about 43° C.

Thus, the EPS device 110 may be able to control the temperature of the rubber 112b to be lower than or equal to a predetermined temperature that is lower than or equal to 60° C. when stretching the uncoated portions 12a by holding the electrode sheet 10 between the pressure roll 112 and the support roll 111. The EPS device 110 may be configured such that the rubber 112 of the outer surface of the pressure roll 112 satisfies the expression y1≥y2≥0.8×y1, where y1 is the modulus of longitudinal elasticity of the rubber 112 at 25° C. and y2 is the modulus of longitudinal elasticity of the rubber 112 at 60° C. This serves to stabilize the modulus of longitudinal elasticity of the pressure roll 112 in use in the EPS device 110. That is, the modulus of longitudinal elasticity of the pressure roll 112 in use in the EPS device 110 is stable relative to the temperature increase. The deformation of the pressure roll 112 is controlled to a certain level, so that heat generation is reduced. As a result, it is possible to stabilize the amount of elongation of the uncoated portions 12a of the electrode sheet 10 that is stretched by the EPS device 110. Note that the pressure roll 112 has been described hereinabove. As illustrated in FIG. 6, when the outer surface of the support roll 111 is the rubber 111b, the rubber 111b may also use the same rubber material as that of the pressure roll 112. It is expected that this allows the support roll 111 to reduce the heat generation of the rubber 111b likewise and to control the size of the bulge 111b1 to be smaller. Through the test, the present inventor varied the compound of the rubber used for the support roll 111 and the pressure roll 112, and used various types of rubbers with varied physical properties for the support roll 111 and the pressure roll 112. As a result, it was confirmed that by appropriately adjusting the physical properties of the rubber as described hereinabove, the deformation of the pressure roll 112 was controlled to a certain level and heat generation was reduced.

### Example

Table 1 shows specific physical properties of an example of the rubber material used for the pressure roll 112 of the EPS device 110 proposed herein. According to the present inventor's discovery, the use of the rubber that exhibits the physical properties shown in Table 1 for the pressure roll 112 controls the deformation of the pressure roll 112 to a certain level and reduces heat generation. As a result, it is possible to stabilize the amount of elongation of the uncoated portions 12a of the electrode sheet 10 that is stretched by the EPS device 110. Herein, the rubber used for the pressure roll 112 is a natural rubber-based (NR-based) compounded rubber. However, the type of the rubber used for the pressure roll 112 is not limited thereto, and it is possible to use other types of rubbers that have similar physical properties. From such a viewpoint, the rubber used for the pressure roll 112 may be, for example, urethane-based rubber, ethylene propylene diene rubber (EPD) M-based rubber, fluorinated compounded rubber, and the like.

TABLE 1

| Physical properties | Example | Target value |
|---|---|---|
| JIS-A Hardness (HS) | 92 | 92 ± 3 |
| Tensile strength (MPa) | 27 | 25-32 |
| Elongation rate (%) | 400 | 370-450 |
| Tear strength (kN/m) | 50 | ≥45 |
| Compression set 30° C. × 72 h | 24 | — |
| Compression set 60° C. × 72 h | 43 | — |
| Modulus of longitudinal elasticity | 23 | 23 ± 3 |
| (MPa 25° C.) | | |
| Modulus of longitudinal elasticity | 17 | Modulus of longitudinal |
| (MPa 60° C.) | | elasticity (MPa 25° C.) × |
| | | 0.9 or higher |
| Modulus of longitudinal elasticity | 14 | — |
| (MPa 80° C.) | | |
| Modulus of longitudinal elasticity | 12 | — |
| (MPa 100° C.) | | |
| Modulus of longitudinal elasticity | 11 | — |
| (MPa 120° C.) | | |
| Linear expansion | 1.60 | — |
| coefficient 10⁻⁴° C. | | |

### Hardness of Rubber 112b

In the example shown in Table 1, the rubber 112b used for the pressure roll 112 10 had a hardness of 92 (Hs) as determined by a durometer (type A) according to JIS standard. According to the present inventor's discovery, the hardness of the rubber 112b used for the pressure roll 112 may be, for example, about 92±3 (Hs).

### Tensile Strength of Rubber 112b

In the example shown in Table 1, the rubber 112b used for the pressure roll 112 had a tensile strength of 27 (MPa). According to the present inventor's discovery, the hardness of the rubber 112b used for the pressure roll 112 may be, for example, about 92±3 (Hs). Note that the tensile strength herein may be measured by an autographic recorder (tensile and compression strength tester). The temperature at the time of measurement may be, for example, room temperature (25° C.). For the autographic recorder, any commercially available device may be used.

### Elongation Rate of Rubber 112b

In the example shown in Table 1, the rubber 112b used for the pressure roll 112 had an elongation rate (%) of 400(%). According to the present inventor's discovery, the elongation rate of the rubber 112b used for the pressure roll 112 may be, for example, about 370% to about 450%. Note that the elongation rate herein may be measured by an autograph. The temperature at the time of measurement here may also be room temperature (25° C.).

### Tear Strength of Rubber 112b

In the example shown in Table 1, the rubber 112b used for the pressure roll 112 had a tear strength (kN/m) of 50 (kN/m). According to the present inventor's discovery, the tear strength of the rubber 112b used for the pressure roll 112 may be, for example, higher than or equal to about 45 (kN/m). When the rubber 112b has a tear strength of higher than or equal to about 45 (kN/m), the rubber 112b used for the pressure roll 112 is unlikely to break during the EPS processing. Note that the tear strength (kN/m) herein may be measured by an autograph. The temperature at the time of measurement here may also be room temperature (25° C.).

### Modulus of Longitudinal Elasticity

In the example shown in Table 1, the rubber 112b used for the pressure roll 112 had a modulus of longitudinal elasticity (MPa) of 23 MPa at 25° C., 17 MPa at 60° C., 14 MPa at 80° C., 12 MPa at 100° C., and 11 MPa at 120° C. Note that the modulus of longitudinal elasticity of the rubber 112b used for the pressure roll 112 herein may be also measured by an autograph. The temperature at the time of measurement here may also be room temperature (25° C.). The modulus of longitudinal elasticity of the rubber 112b used for the pressure roll 112 has temperature dependency, as shown in Table 1. From the perspective of obtaining the advantageous effect of being able to stabilize the amount of elongation of the uncoated portions 12a of the electrode sheet 10 that is stretched by the EPS device 110, it is desirable that the modulus of longitudinal elasticity be stable in the use temperature range of about 25° C. to about 60° C. From such a viewpoint, according to the present inventor's discovery, the rubber 112b used for the pressure roll 112 may have a modulus of longitudinal elasticity (MPa) of, for example, about 23±3 MPa at 25° C., and the modulus of longitudinal elasticity of the rubber 112b used for the pressure roll 112 at 60° C. may be higher than or equal to 80%, preferably higher than or equal to 90%, of the modulus of longitudinal elasticity at 25° C.

### Compression Set and Linear Expansion Coefficient (10⁻⁴° C.)

In the example shown in Table 1, the rubber 112b used for the pressure roll 112 had a compression set of 24 at 30° C.×72 h and 43 24 at 60° C.×72 h. The compression set herein is specified according to Determination of compression set (JIS K 6262). In addition, the rubber 112b used for the pressure roll 112 had a linear expansion coefficient (10⁻⁴° C.) of 1.60. The linear expansion coefficient (10⁻⁴° C.) is specified by a thermal expansion coefficient measuring device. Note that the compression set at 30° C.×72 h and at 60° C.×72 h and the linear expansion coefficient (10⁻⁴° C.) shown here are merely examples. For the thermal expansion coefficient measuring device, any commercially available device may be used.

To the present inventor's knowledge, it is believed that the compression set and the linear expansion coefficient (10⁻⁴° C.) of the rubber 113b used for the pressure roll 112 are not as important as the other physical properties, i.e., hardness, tensile strength, elongation rate, and tensile strength, from the perspective of obtaining the advantageous effect of stabilizing the amount of elongation of the uncoated portions 12a of the electrode sheet 10 that is stretched by the EPS device 110. The compression set and the linear expansion coefficient (10⁻⁴° C.) may be within the range of common physical properties of the rubber 112b used for the pressure roll 112.

Herein, the rubber 112b used for the pressure roll 112 may have varied physical properties depending on the conditions in manufacture, the amounts of additive agents, the conditions in vulcanization, and the like. The column labeled “Target value” in Table 1 shows the range of physical properties of the rubber 112b used for the pressure roll 112 that the present inventor considers as preferable. According to the present inventor's discovery, the use of the rubber that exhibits the physical properties shown in Table 1 for the pressure roll 112 controls the deformation of the pressure roll 112 to a certain level and reduces heat generation. As a result, it is possible to stabilize the amount of elongation of the uncoated portions 12a of the electrode sheet 10 that is stretched by the EPS device 110.

As described above, according to the present inventor's discovery, the use of the rubber that exhibits the physical properties shown in Table 1 for the pressure roll 112 of the EPS device 110 controls the deformation of the pressure roll 112 to a certain level and reduces heat generation. As a result, it is possible to stabilize the amount of elongation of the uncoated portions 12a of the electrode sheet 10 that is stretched by the EPS device 110. The rubber that exhibits the physical properties as described above, although special, may be obtained from a rubber manufacturer by specifying the physical properties at ordering. An example of the rubber manufacturer that can manufacture the rubber that exhibits the physical properties described above is Chugoku Rubber Industry, Co., Ltd.

Thus, the pressure roll 112 of the EPS device 110 may be a rubber roll at least the outer circumferential surface of which includes the rubber 112b, and the rubber 112 may satisfy the expression y1≥y2≥0.8×y1, where y1 is the modulus of longitudinal elasticity at 25° C. and y2 is the modulus of longitudinal elasticity at 60° C. When the EPS device 110 uses such a pressure roll 112, the deformation of the pressure roll 112 is controlled to a certain level, and heat generation is reduced. As a result, it is possible to stabilize the amount of elongation of the uncoated portions 12a of the electrode sheet 10 that is stretched by the EPS device 110.

From such a viewpoint, the rubber 112b used for the pressure roll 112 may have a modulus of longitudinal elasticity at 25° C., y1, in the range 20 MPa≤y1≤26 MPa. In addition, the rubber 112b may have a JIS-A hardness at 25° C. of 92±3 (Hs). In this case as well, the deformation of the pressure roll 112 is controlled to a certain level, and heat generation is reduced. As a result, it is possible to stabilize the amount of elongation of the uncoated portions 12a of the electrode sheet 10 that is stretched by the EPS device 110.

In addition, the EPS device 110 may be configured to control the temperature increase of the rubber to be lower than or equal to a predetermined temperature that is lower than or equal to 60° C. when stretching the uncoated portions 12a by holding the uncoated portions 12a of the electrode sheet 10 between the pressure roll 112 and the support roll 111. From such a viewpoint, it is possible to blow a cooling gas (e.g., air) onto the pressure roll 112, and it is also possible to provide a heat dissipation means such as cooling fins and a heat sink on the side surface of the pressure roll 112.

Herein, the rubber material used for the pressure roll 112 of the EPS device 110 is described. As illustrated in FIG. 5, as with the pressure roll 112, the support roll 111 of the EPS device may include the rubber 111b formed on its surface. When the rubber 111b is formed on the surface of the support roll 111 of the EPS device, the rubber 111b used for the support roll 111 and the rubber 112b used for the pressure roll 112 may have the same physical properties. For example, the same material may be used for both the rubber 111b used for the support roll 111 and the rubber 112b of the pressure roll 112. That is, both the rubber 111b used for the support roll 111 and the rubber 112b of the pressure roll 112 may have the same physical properties and compositions. This allows the pressure roll 112 and the support roll 111 to apply a stretching force to both surfaces of the electrode sheet 10 in the same manner when stretching the uncoated portions 12a by holding the uncoated portions 12a of the electrode sheet 10 therebetween. This makes it possible to stretch the uncoated portions 12a appropriately.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

### Item 1:

An electrode sheet manufacturing apparatus for manufacturing an electrode sheet, the electrode sheet comprising a current collector made of an oblong metal foil, an unformed portion defined along a longitudinal axis of the current collector at a predetermined widthwise position in the current collector, and an active material layer formed on a portion of the current collector other than the unformed portion, the apparatus including:

a conveyor device conveying the electrode sheet along a predetermined conveyance passage;
a support roll disposed in the conveyance passage and supporting a first surface of the electrode sheet along a width axis;
a pressure roll disposed opposite the support roll and pressing a second surface of the electrode sheet;
a pressing mechanism holding the electrode sheet and pressing the pressure roll toward the support roll; and
a drive device rotatively driving the support roll, wherein:

the pressure roll is disposed so as to hold the unformed portion of the electrode sheet between the pressure roll and the support roll, except for a portion of the electrode sheet on which the active material layer is formed;
the pressure roll comprises a rubber roll at least an outer circumferential surface of which being made of rubber; and
the rubber satisfies the following expression: y1≥y2≥0.8×y1, where y1 is the modulus of longitudinal elasticity of the rubber at 25° C. and y2 is the modulus of longitudinal elasticity of the rubber at 60° C.

### Item 2:

The electrode sheet manufacturing apparatus according to item 1, wherein the rubber satisfies the following expression: 20 MPa≤y1≤26 MPa, where y1 is the modulus of longitudinal elasticity of the rubber.

### Item 3:

The electrode sheet manufacturing apparatus according to item 1 or 2, wherein the rubber has a JIS-A hardness at 25° C. of 92±3 (Hs).

### Item 4:

The electrode sheet manufacturing apparatus according to any one of items 1 through 3, configured to control a temperature increase of the rubber to be lower than or equal to a predetermined temperature that is lower than or equal to 60° C. when stretching the unformed portion by holding the unformed portion of the electrode sheet between the pressure roll and the support roll.

### Item 5:

The electrode sheet manufacturing apparatus according to any one of items 1 through 4, wherein the support roll includes a rubber roll at least an outer circumferential surface of which being made of rubber.

### Item 6:

The electrode sheet manufacturing apparatus according to item 5, wherein the rubber used for the support roll and the rubber used for the pressure roll have the same physical properties.

What is claimed is:

1. An electrode sheet manufacturing apparatus for manufacturing an electrode sheet, the electrode sheet comprising a current collector made of an oblong metal foil, an unformed portion defined along a longitudinal axis of the current collector at a predetermined widthwise position in the current collector, and an active material layer formed on a portion of the current collector other than the unformed portion, the apparatus comprising:
a conveyor device conveying the electrode sheet along a predetermined conveyance passage;
a support roll disposed in the conveyance passage and supporting a first surface of the electrode sheet along a width axis;
a pressure roll disposed opposite the support roll and pressing a second surface of the electrode sheet;
a pressing mechanism holding the electrode sheet and pressing the pressure roll toward the support roll; and
a drive device rotatively driving the support roll, wherein:
the pressure roll is disposed so as to hold the unformed portion of the electrode sheet between the pressure roll and the support roll, except for a portion of the electrode sheet on which the active material layer is formed;
the pressure roll comprises a rubber roll at least an outer circumferential surface of which being made of rubber; and
the rubber satisfies the following expression: y1≥y2≥0.8×y1, where y1 is the modulus of longitudinal elasticity of the rubber at 25° C. and y2 is the modulus of longitudinal elasticity of the rubber at 60° C.

2. The electrode sheet manufacturing apparatus according to claim 1, wherein the rubber satisfies the following expression: 20 MPa≤y1≤26 MPa, where y1 is the modulus of longitudinal elasticity of the rubber.

3. The electrode sheet manufacturing apparatus according to claim 1, wherein the rubber has a JIS-A hardness at 25° C. of 92±3 (Hs).

4. The electrode sheet manufacturing apparatus according to claim 1, configured to control a temperature increase of the rubber to be lower than or equal to a predetermined temperature that is lower than or equal to 60° C. when stretching the unformed portion by holding the unformed portion of the electrode sheet between the pressure roll and the support roll.

5. The electrode sheet manufacturing apparatus according to claim 1, wherein the support roll includes a rubber roll at least an outer circumferential surface of which being made of rubber.

6. The electrode sheet manufacturing apparatus according to claim 5, wherein the rubber used for the support roll and the rubber used for the pressure roll have the same physical properties.
